(19) United States
(12) Patent Application Publication
(10) Pub. No.: US 2023/0266718 A1
(43) Pub. Date: Aug. 24, 2023

(54) CONTROL LOOP OPTIMIZATION

(71) Applicant: SIEMENS AKTIENGESELLSCHAFT, München (DE)

(72) Inventors: Maximilian Pfister, Erlangen (DE); Benjamin Amschler, Heinersreuth (DE)

(21) Appl. No.: 18/023,724

(22) PCT Filed: Jul. 15, 2021
(86) PCT No.: PCT/EP2021/069728

§ 371 Date: Feb. 27, 2023

(30) Foreign Application Priority Data
Aug. 31, 2020 (EP) 20193566.5

(51) Int. Cl. G05B 13/00

(52) U.S. Cl. CPC G05B 13/00

(57) ABSTRACT

A method of optimizing a control loop of a converter, such as a control system of the converter, includes acquiring actual values of a drive system powered by the converter, inferring, based on at least one machine learning model and the actual values, one or more adjustments of control parameters of the control loop for improving the control accuracy, and outputting the one or more adjustments for adapting control parameter values.

This application is the National Stage of International Application No. PCT/EP2021/069728, filed Jul. 15, 2021, which claims the benefit of European Patent Application No. EP 20193566.5, filed Aug. 31, 2020. The entire contents of these documents are hereby incorporated herein by reference.

### TECHNICAL FIELD

The present disclosure relates to closed loop control for drive systems.

### BACKGROUND

Tuning a control loop is the adjustment of its control parameters (e.g., proportional band/gain, integral gain/reset, derivative gain/rate) to optimum values for a desired control response. Stability (e.g., no unbounded oscillation) is a basic requirement, but beyond that, different systems have different behavior, different applications have different requirements, and requirements may conflict with one another.

PID controllers are widespread in industry, being the most popular controllers for decades. Hence, even small improvements in PID design may have major impact worldwide. There are many theoretical and practical papers on PID tuning algorithms, in time and frequency domain. The algorithms are using analytical, graphical, or empirical methods, including artificial intelligence.

There are a number of methods for tuning a PID loop. The most effective methods generally involve the development of some form of process model, then choosing P, I, and D based on the dynamic model parameters. Manual tuning methods may be relatively time-consuming, particularly for systems with long loop times.

Traditional tuning techniques such as modulus optimum or symmetrical optimum may be applied to the design of control loops for many power electronic applications. When directly implemented in digital control systems, this will lead to reduced stability margins since the sampling effects are not taken into account for the controller design.

In the field of electrical drives, two methods are frequently employed in this parametric optimization: the AVO and SO criterions (e.g., Absolute Value Optimum (AVO) and Symmetric Optimum (SO) criterions).

The balance of these effects is achieved by loop tuning to produce the optimal control function. The tuning constants are to be derived for each control application, as the tuning constants depend on the response characteristics of the complete loop external to the controller. For the overall control function, Kp, Kd, and Ki are all non-negative and denote the coefficients for the proportional, integral, and derivative terms, respectively (sometimes denoted P, I, and D). Therein, Kp is the proportional gain, a tuning parameter, Ki is the integral gain, another tuning parameter, and Kd is the derivative gain, yet another tuning parameter.

For example, manual tuning may be performed but requires experienced personnel.

### SUMMARY AND DESCRIPTION

The scope of the present disclosure is defined solely by the appended claims and is not affected to any degree by the statements within this description.

The present embodiments may obviate one or more of the drawbacks or limitations in the related art. For example, control accuracy of a control loop for a drive system is improved, for example, in an automated way. As another example, which parameters need further tuning are identified, for example, in case multiple parameters need to be tuned.

According to a first aspect, a method of optimizing a control loop accuracy of a converter (e.g., a control system of a converter) is provided. The method includes acquiring actual values of a drive system powered by the converter. The method also includes inferring, based on a machine learning model and the actual values, one or more adjustments of control parameters of the control loop for improving the control accuracy, and outputting the adjustments for adapting the control parameter values.

According to a second aspect, a converter operative to perform the method acts according to the first aspect is proposed.

According to a third aspect, a method of training a machine learning model is provided. The method includes training a machine learning model based on actual values of a drive system (e.g., virtual drive system). The actual values include actual rotation speed, rotation speed setpoint, actual torque, and control difference.

### BRIEF DESCRIPTION OF THE DRAWINGS

FIG. 1 shows a schematic illustration of a converter powering a drive system.

FIG. 2 shows a schematic illustration of different stages during a lifecycle of a drive system.

FIG. 3 shows a schematic illustration of a step response of a control loop before optimization.

FIG. 4 shows a schematic illustration of an optimization of a control loop according to a first embodiment.

FIG. 5 shows a schematic illustration of a step response of a control loop after optimization.

FIG. 6 shows oscillations of the control difference after a step response.

FIG. 7 shows a schematic illustration of an optimization of a control loop according to a second embodiment.

FIG. 8 shows a schematic illustration of an optimization of a control loop according to a third embodiment.

FIG. 9 shows a schematic illustration of data handling, as well as training and creation of a first machine learning model and a second machine learning model.

FIG. 10 shows a schematic illustration of a setup for generating a data set for training and/or testing one or more machine learning models.

### DETAILED DESCRIPTION

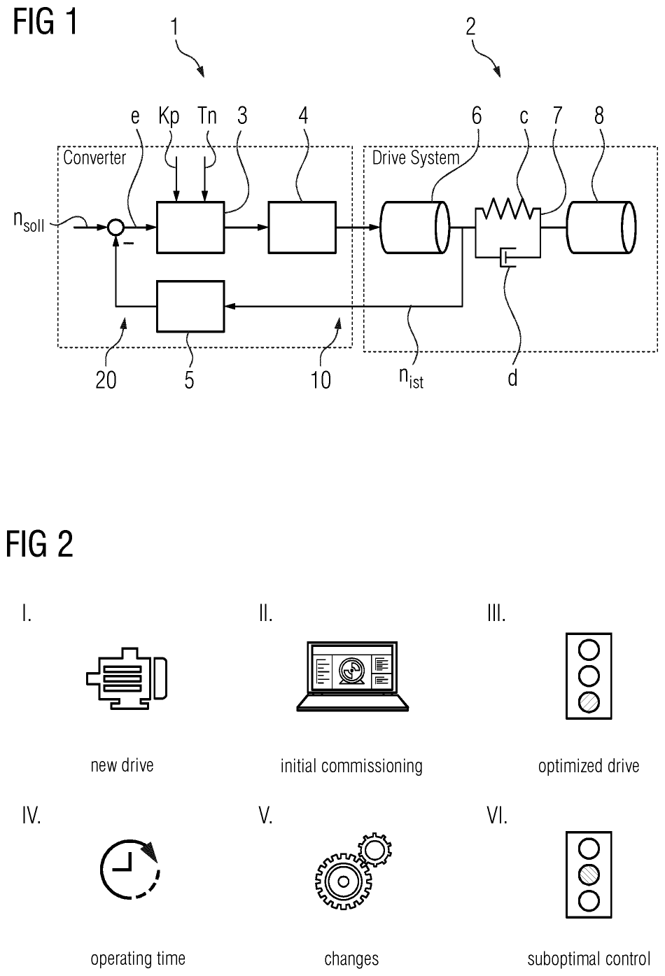

FIG. 1 shows a converter 1 and a drive system 2. Control of the drive system 2 is performed by the converter 1 and a control system 20 that may be integrated into the converter 1. The converter 1 is part of a control loop 10 and may include a processor and a memory to control the drive system 2. The converter 1 thus powers the drive 6. In general, a mechanical system that is driven by a motor may be simplified by a two-mass-system. The connection between these two loads, the coupling, is described by stiffness (c) and a damping (d). The drive 6 is hence coupled with a spring-damper system 7 that is coupled with a load 8, which together creates a two-mass oscillator. A current control circuit is simplified as a closed-loop control element 4 in FIG. 1. Therein, Kp corresponds to the damping of the motor in relation to the setpoint value, and the integral time Tn of the integrator acts like a spring. The proportional gain factor Kp is proportional to the inductance of the motor winding, whereas the integral time Tn is proportional on the current controller 4 clock cycle. Optimization may include optimizing the proportional gain factor optimization, Kp, and/or the integral time optimization, Tn.

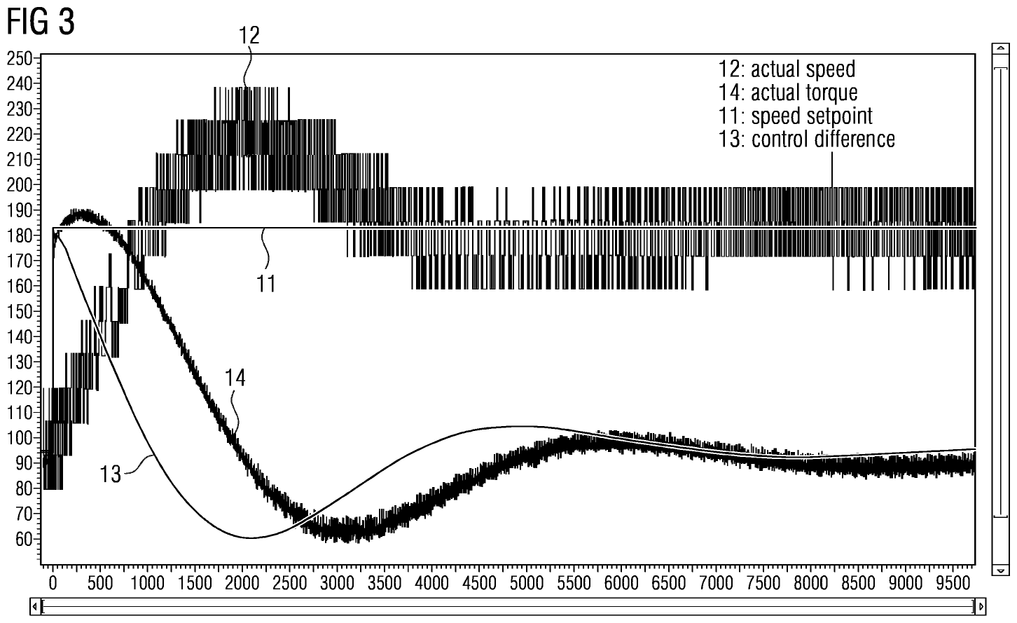

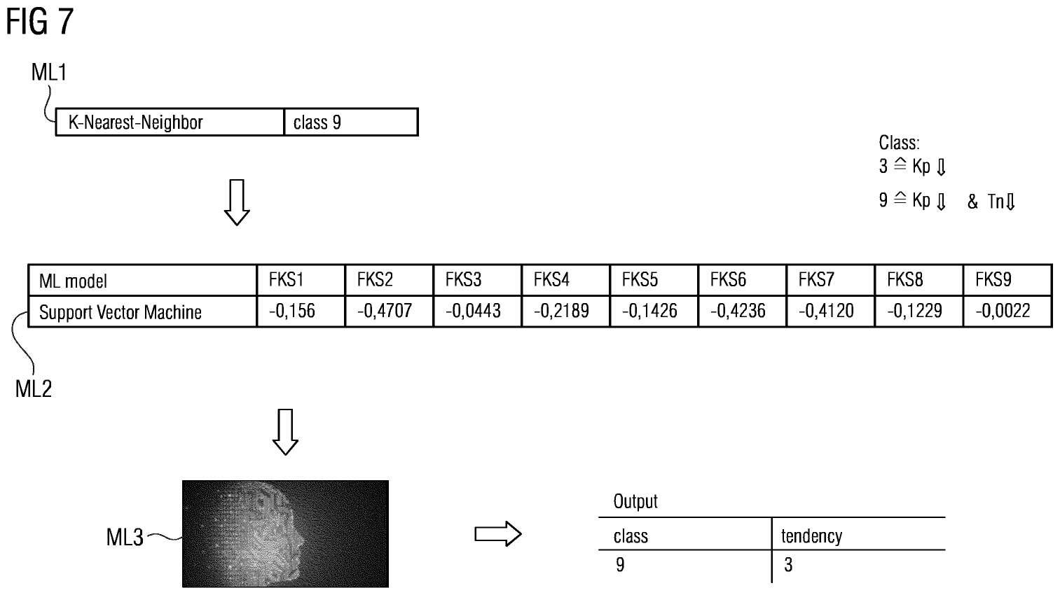

The actual speed nᵢₛₜ (e.g., rotational speed) may be controlled to yield the speed setpoint nₛₒₗₗ. The control loop 10 accuracy may then be determined based on speed setpoint jumps (e.g., on a step response), as shown in FIG. 3 and FIG. 5. The step response of the speed-controlled system 2 may be traced with a “measuring function” (e.g., integrated into a commissioning software application, such as STARTER/SCOUT from SIEMENS), as shown in FIG. 7. One or more actual values of the drive system may thus be acquired.

The control loop 10 for controlling the drive system 2 may, for example, be commissioned or initialized with default-settings. The controller settings of the controller 1 (e.g., proportional gain factor Kp and integral time Tn) may thus be preset automatically. This may be done by the auto-configuration of SIEMENS' DRIVE-CLiQ or by entering the motor code number into the commissioning tool, or the control settings may be manually entered in the converter 1 by a commissioning engineer.

The control loop 10 may be adjusted using one or more control parameters (e.g., Kp and Tn as shown). For example, Kp and/or Tn may be used as control parameters of the PI speed controller 3. By way of the methods and systems provided herein, a recommendation for control action may be obtained in order to adjust the control parameters Kp and/or Tn. Kp represents the proportional amplification of the PI speed controller 3, whereas Tn corresponds to the integral time of the PI speed controller 3. Tn is the time that the I-component of the controller would require to produce the same positioning signal that the P-component forms immediately once the control deviation is present. Via the method proposed, a recommendation for control action may be obtained to adjust the control parameter Tn and/or Kp. In the case of a bad encoder signal (e.g., noisy actual speed value), the value may be smoothed by a PT1 filter 5. A common smoothing time Tn may be set to about 2-3 ms. As shown in FIG. 1, the speed controller may be a PI controller 3.

Turning to FIG. 2, exemplary points in time during the lifecycle of a drive system are shown. First, in I., a new drive is produced or installed. For example, when inserting a new drive to a project, the Kp factor gets pre-assigned depending on the motor inertia and an additional factor of ⅓. During the commissioning of a machine, II., the drive control is optimized by the commissioning personnel. The drive control, mainly the speed controller and, if necessary, smoothing times, is optimized such that the behavior of the drive train, consisting of motor, gearbox, cardan shafts, belts, etc., is optimally matched to each other at this time, III. Due to the ongoing operation of a machine, IV., its mechanics are subject to often not inconsiderable wear, which may change, V., the behavior of the drive train as a whole. Operational environmental influences, such as temperature or oil pressure, may also have an influence that may not have been present during the commissioning phase. However, there is often no re-optimization of the drive train and its control loop, respectively, although its properties have changed significantly due to wear or conversion work. This may result in sub-optimal control and sub-optimal control settings, VI.

So far, the problem is addressed as follows: 1. The plant operator usually did not know that the drive system is no longer optimally controlled according to the desired optimization criteria. The drive system is kept in operation until errors occur and a service technician has to be called. This may lead to a plant shutdown. 2. A service technician regularly checks the behavior of the drive system.

The control quality of the drive system may, in one or more of the presented embodiments, be evaluated in relation to the optimization criterion “Symmetric Optimum”, SO, and a recommendation for one or more actions may be provided to set the control parameters. For this purpose, a speed setpoint jump may be switched and passed on to the drive system. The control loop parameters speed setpoint, speed control value, torque output, and control difference may then be read out. FIG. 3 shows a speed setpoint jump with the corresponding jump responses of the above parameters before optimization of the control loop.

The speed setpoint 11 (e.g., pink) has been increased in jumps. At the time of the jump, the control difference 13 (e.g., blue) is equal to the jump height, because there was no control difference before the jump. In one embodiment, there is no setpoint filter in this embodiment that passes the control loop's setpoint (e.g., through a first-order lag filter) before the controller receives the signal. The torque 14 of the drive (e.g., black) follows the control difference 13 with a time delay, which occurs due to smoothing times. The unsmoothed speed value 12 (e.g., orange) is adjusted to the target speed setpoint 11. Often, drive systems are only rarely or not maintained at all, and the control is not optimized for changes. As a result, the system is no longer controlled according to the previously defined optimization criterion.

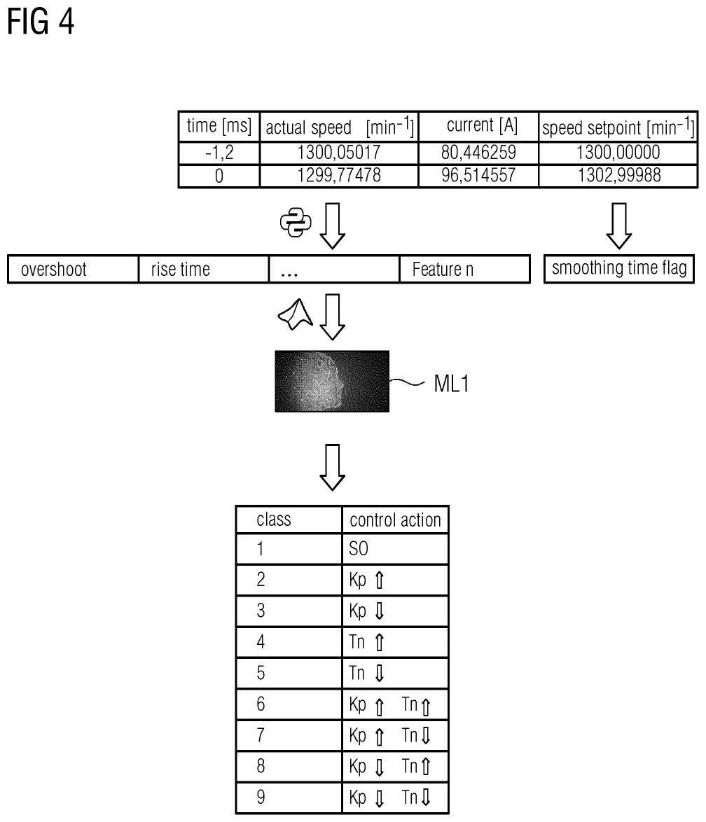

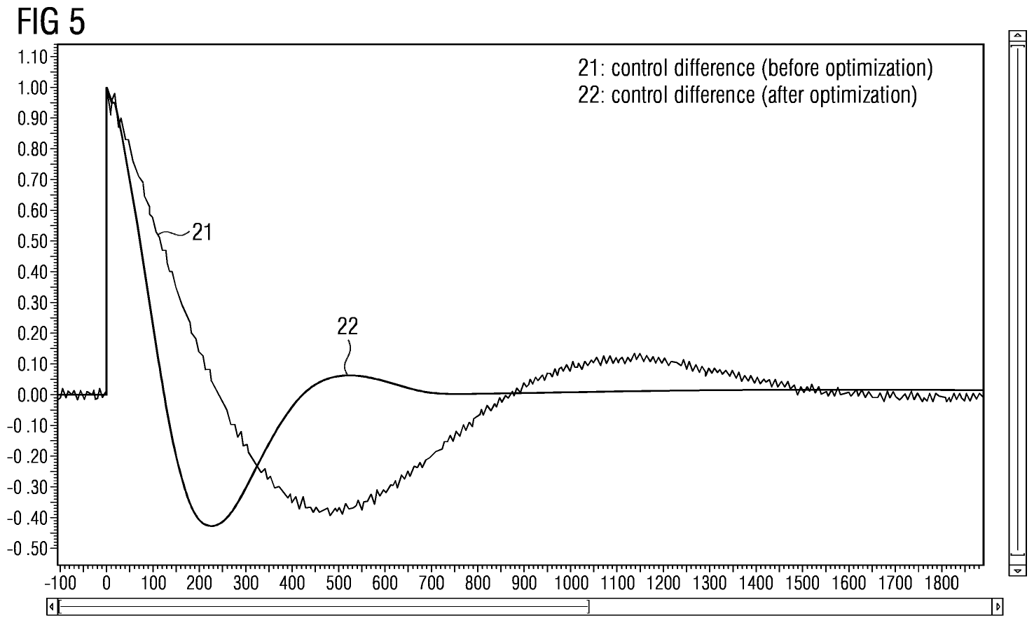

In the following, an optimization of a control loop will be described in connection with FIG. 4. The result of the optimization is illustrated in FIG. 5, which shows two jump responses of a system's control difference: Once before the control loop has been optimized, 21 (e.g., red), with the developed method according to a first and or second procedure; and once after optimization, 22 (e.g., blue).

As shown in FIG. 4, the starting point of the optimization may be raw data as sampled or measured or otherwise acquired from the drive system and/or the converter. The raw data of the measurements may be available in certain data format, such as the CSV format. Each measurement may include one or more of the following control parameters, as shown in FIG. 4: speed value (e.g., actual rotation speed value, in rotations per minute; torque value (e.g., actual torque in Newton-meter); speed setpoint (e.g., in rotations per minute); control difference (e.g., in rotations per minute).

Further, actual current values feeding the drive may be acquired, as shown in FIG. 4.

Based on one or more of these actual values, feature extraction may be performed. To that end, a script (e.g., a Python script) may be used to read the raw data and generate the features (e.g., characteristic features). The features may all or at least in part refer to the control difference of the control loop. For example, the features may include one or more of the following: ü—overshoot of the control difference; Trise—rise time, which may be defined as Trise=T90−T10 (rise time); Tmax—time of maximum overshoot; T50—time until the control difference has been adjusted by half; Taus—settling time, where Taus is the time until the control difference was fixed by 97% or 100% or another percentage depending on a tolerance chosen (setting time).

Additional features (e.g., based on the control difference) may include: T90—time until the control difference has been adjusted by 90%; T10—time until the control difference has been adjusted by 10%; ΔT—ΔT may be defined as ΔT=Tmax−Tan, where Tan is the control rise time that corresponds to T97−T0 (rise time).

Further features may be formed from the actual values. If the actual values are used for training (e.g., training data), a label (also later referred to as class) may be assigned to the one or more features as will be described further below. If the actual values are used for inference (e.g., of an adjustment for optimization of the control loop), a label (also referred to as class) will be inferred by one or more machine learning models based on the feature(s) (e.g., values) input.

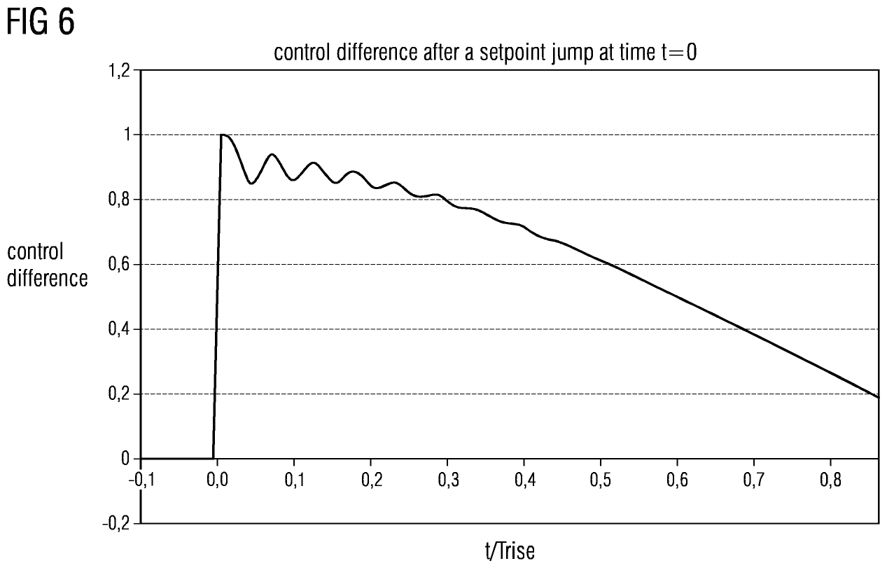

In addition, it may be checked whether the smoothing time is too small for the respective measurement. For this purpose, as shown in FIG. 6, the control difference is considered during a time period (e.g., until the rise time T50 or the settling time Taus is reached). If the control difference during that time period has a higher frequency oscillation that raises the control difference (e.g., at least once or twice (or another specified number of times) by at least 2% or 5% (or another specified percentage) of the jump height), the smoothing of the actual value of the speed or rotational speed may need to be increased.

Thus, in addition to feature extraction, it is checked during data preprocessing of the actual values whether the time constant of the smoothing time of the actual speed is too small for the respective measurement. For this purpose, the control difference may be considered (e.g., up to the time T50 as mentioned in the above). For the increase in the smoothing (e.g., actual speed value smoothing), there are two conditions, one of which is to be met. First, if the control difference has at least two higher frequency oscillations, one of which raises the value of the control difference by at least 9% of the jump height in the short term, it is recommended to increase the smoothing time. Second, the speed stability may be increased if at least five higher frequency oscillations occur during the period under consideration, at least two of which increase the control difference by more than 5% of the jump height. In FIG. 6, such a higher-frequency oscillation of the control difference is shown as a function of time tin units of Tan.

Returning to FIG. 4, the extracted features may be used as input for the machine learning model ML1, or as will be described later, for the machine learning model ML2. As shown in FIG. 4, a flag indicating whether the smoothing of the actual value of the speed (e.g., rotational speed) should be increased, as described in the above, may be determined as well (e.g., as a result of the Python script).

Further, the extracted features may be normalized. The normalization of the features derived from the actual values and a first optimization procedure will be described in the following. For example, the features are fed into Matlab. Then, the required features may be selected and normalized. For the normalization of time, the time T50 may be used. The normalized features may include: overshoot of the control difference; rise time Trise of the control difference normalized to T50; time difference ΔT normalized to T50; settling time Taus normalized to T50; or any combination thereof.

Hence, normalization may be performed referring to T50. Further, the features may also be scaled using the mean and the standard deviation of the respective feature.

With the resulting features, all of which may refer to the control difference, a machine learning model ML1 may then be trained. Later on, the trained machine learning model may be used for inference based on the features input. The machine learning model may be an artificial neural network, a K-Nearest-Neighbor model, Support Vector Machine, or Decision Tree, such as a Random Forrest. In one embodiment, a K-Nearest-Neighbor model is used.

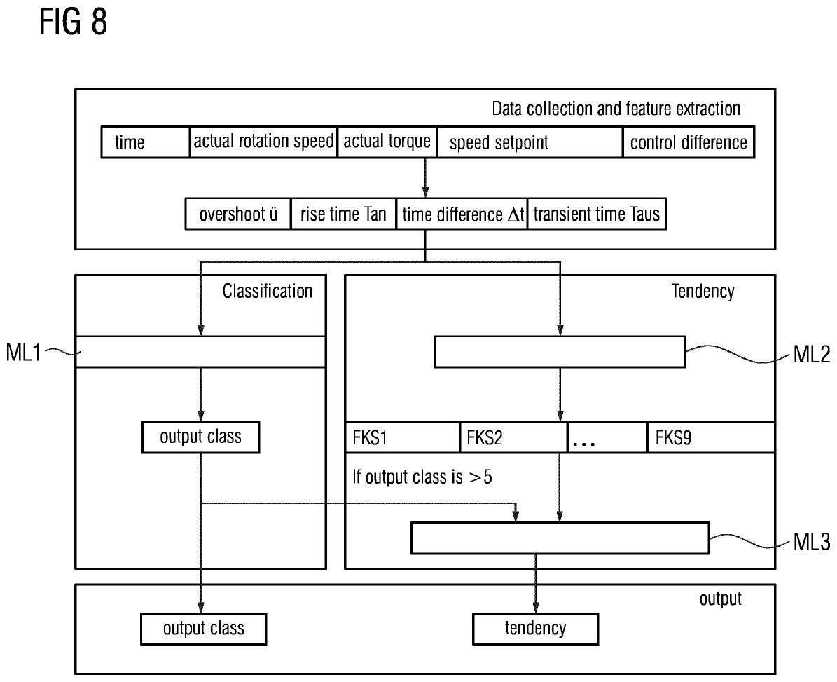

The machine learning model ML1 may classify the features input into a plurality of output classes. In FIG. 4, nine output classes are shown. In addition, as shown in the embodiments in FIGS. 7 and 8, the features (e.g., same features) may be input into a second machine learning model (e.g., a support vector machine, such as with the coding “OneVsOne”), as will also be described later.

As shown in FIG. 4, the machine learning model ML1 classifies the input into nine different classes. Another classification schema may be chosen (e.g., classification may be performed into a different number of classes). The classes may have the following adjustment and, for example, control action associated with the adjustment:

class 1: no adjustment necessary (e.g., because the symmetric optimum, SO, is already present)

class 2: increase Kp (by doubling)

class 3: decrease Kp (by half)

class 4: increase Tn (by doubling)

class 5: decrease Tn (by half)

class 6: increase Kp and Tn (by doubling)

class 7: increase Kp (by doubling) and decrease Tn (by half)

class 8: decrease Kp (by half) and increase Tn (by doubling)

class 9: decrease Kp and Tn (by half)

Instead of doubling or halving the respective control parameters, other adjustment factors for adjusting the control parameters may be chosen. However, it has been found that the control loop remains stable under halving or doubling the current control parameter values.

As output data, the machine learning model ML1 may also provide a measure (e.g., a probability) for each class. Additionally or alternatively to the first machine learning model ML1, a second machine learning model, such as a support vector machine, may be used in order to classify the input features according to the classification schema. The support vector machine may provide an error correction sum FKS1, . . . , FKS9 for each class as output. The smaller the absolute value of the error correction sum FKS1, . . . , FKS9 the higher the measure, or probability, that the measurement belongs to the respective class.

If the machine learning model ML1 provides classes 1 to 5 as a result, the result may be used (e.g., directly) for an adjustment of the control loop. If the machine learning model provides any one of the classes 6 to 9 (e.g., where both Kp and Tn may need to be adjusted), as a result, this may be used for adjusting the control loop settings accordingly.

The result of an optimization is shown in FIG. 5, where the control difference before and after optimization is shown. As shown in FIG. 5, the control difference after optimization 22 levels much sooner than control difference before optimization 21. Hence, after optimization, the drive system is adjusted faster, and thereby, the control accuracy is improved.

Now turning to FIG. 7, in case the machine learning model ML1 provides one of the classes 6 to 9 as a result, both Kp and Tn may need to be adjusted. Hence, in general, the case may arise where both Kp and Tn may need to be adjusted. In order to find out which parameter Kp or Tn dominates, a second procedure is provided. The second procedure is applied after the first procedure, as described in connection with FIG. 4. In case of the second procedure, a second machine learning model ML2 is used to classify the input features. For example, a support vector machine may be fed with the features determined, and the results (e.g., error correction sums FKS1, . . . , FKS9) of the support vector machine may be used. The results of the first and second machine learning model ML1, ML2 may then be compared in order to adjust the control parameters of the control loop and/or in order to improve accuracy of the control loop. As shown in FIG. 6, the results of the two machine learning models ML1, ML2 may be further evaluated by comparing the classification and the respective output values. Hence, for the second procedure, the results of two different machine learning models ML1, M12 are compared. The difference between the models is not with respect to the specific parameterization but with respect to the type of machine learning models ML1, ML2.

The input features for the subsequent evaluation by a decision algorithm, which itself may be a machine learning model ML3, are the results of the second machine learning model ML2 (e.g., the (nine) error correction sums FKS1, . . . , FKS9 from the result of the support vector machine, as well as the result, such as the classification, of the first machine learning model ML1). In the present case, this results in a total number of ten features that may be used by the third machine learning model ML3. The outcome of the second procedure, which is performed by decision algorithm, consists of three classes 1, 2, 3 as shown in the following:

| 1 | 2 | 3 |
|---|---|---|
| no domination | Kₚ dominates | Tₙ dominates |

For exemplary reasons, the first procedure and the second procedure have been described in connection with a K-Nearest-Neighbor and a support vector machine. However, for performing the first procedure and/or the second procedure, either an artificial neural network, a Decision Tree model, such as a Random Forrest model, or another machine learning model may be used.

Using the result from the first machine learning model ML1 and the result from the second machine learning model ML2, a recommendation for an adjustment (e.g., a control action) may now also be provided if two or more control parameters are to be adjusted. The following table shows the recommendations for a control action according to all of the possible combinations.

| | | adjustment factor | adjustment factor |
|---|---|---|---|
| First | Second | (control action) | (control action) |
| procedure | procedure | for Kₚ | for Tₙ |
| 1 | — | 1 | 1 |
| 2 | — | 2 | 1 |
| 3 | — | 0.5 | 1 |
| 4 | — | 1 | 2 |
| 5 | — | 1 | 0.5 |
| 6 | 1 | 2 | 2 |
| 6 | 2 | 2 | 1.5 |
| 6 | 3 | 1.5 | 2 |
| 7 | 1 | 2 | 0.5 |
| 7 | 2 | 2 | 0.67 |
| 7 | 3 | 1.5 | 0.5 |
| 8 | 1 | 0.5 | 2 |
| 8 | 2 | 0.5 | 1.5 |
| 8 | 3 | 0.67 | 2 |
| 9 | 1 | 0.5 | 0.5 |
| 9 | 2 | 0.5 | 0.67 |
| 9 | 3 | 0.67 | 0.5 |

The adjustment may be applied to the control loop (e.g., either automatically or may be displayed to a user in order to manually enter the one or more adjustments, such as via a commissioning tool). Again, different adjustment factor may be chosen, but it is important that the direction of change is adhered.

Returning to the embodiment of FIG. 7, the result of the second procedure is that although both Kp and Tn may be raised, it is Kp that influences the behavior of the control loop more (e.g., dominates). In that case, the adjustment and/or control action recommendation may be changed to increase (e.g., only) Kp according to the adjustment factor as shown in the table above.

The whole procedure, including the first procedure and second procedure, for example, may be repeated until the first machine learning model outputs the class 1 (e.g., the symmetrical optimum is reached). The first procedure may be adjusted to identify the absolute value optimum or another desired optimization goal. During the optimization (e.g., repeated optimization), the control action recommendation may change from a recommendation to increase a control parameter to a recommendation to decrease a control parameter. If this is the case, the factors presented in the table above may no longer be used. From this point on, the control parameter may be adjusted so that the control parameter is set in the middle between the (e.g., too high) adjustment factors and the (e.g., too small) adjustment factor of the respective control parameter. Further, care is to be taken to whether the “smoothing of the actual value of the speed” flag is set. If this is the case, the smoothing of the actual value of the speed may be increased, and the parameters Kp and Tn may not be changed.

Turning to FIG. 8, another embodiment is shown. As shown, first, data acquisition is performed. In other words, measurement data representing the actual speed, actual torque, speed setpoint, and control difference is obtained. The respective data points may be time stamped. Based on the data acquired, feature extraction may be performed. The features may include overshoot ü, rise time Trise, time difference ΔT, and settling time Taus.

Based on the features, in a first procedure, a classification using a first machine learning model ML1 is determined. The first machine learning model outputs a single class. The different classes may correspond to the different adjustments and/or control action recommendations. In case the first machine learning model determines that only a single parameter is to be adjusted, the output class and control action (e.g., corresponding control action) may be used or realized directly. In case the output class of the first machine learning model corresponds to an adjustment or control action recommendation of two or more control parameters, the output or results of the second machine learning model are determined in a second procedure. In that case, either the inference by the second machine learning model is started after the inference of the first machine model is obtained, or the inference of the second machine learning model is performed in parallel to the inference of the first machine learning model. In any case, the output or results of the first machine learning model and the second machine learning model are used to determine a tendency of which of the two or more control parameters of the control loop dominates and should solitarily be adjusted. A third machine learning model may be fed with at least part of the output or results of the first machine learning model and the second machine learning model. The third machine learning model may then infer the tendency. The result of the third machine learning model may then be used to adjust the control loop of the drive system. As described earlier, the third machine learning model ML may be any one of a K-Nearest-Neighbor, a support vector machine, an artificial neural network, or a decision tree.

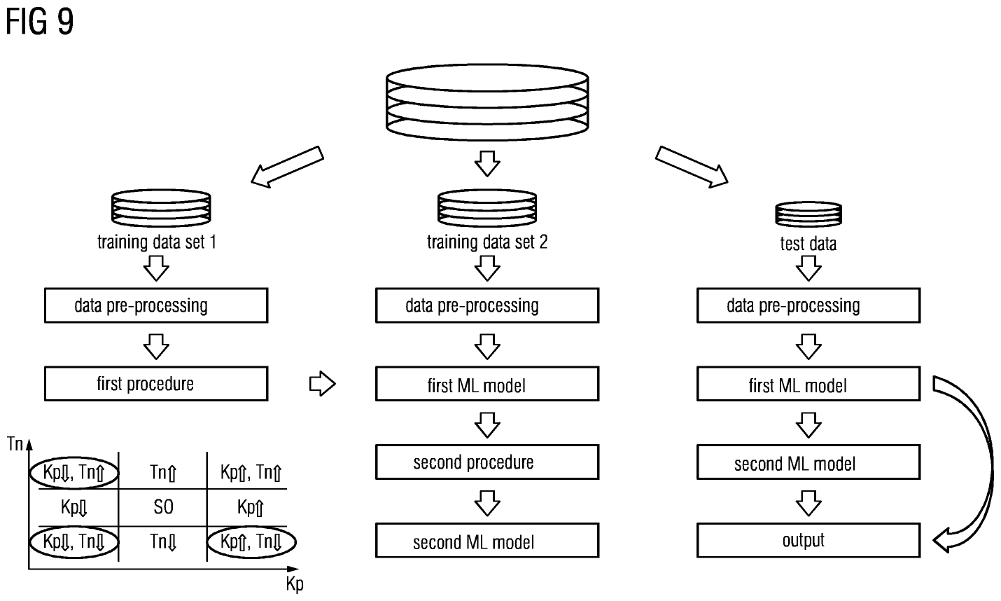

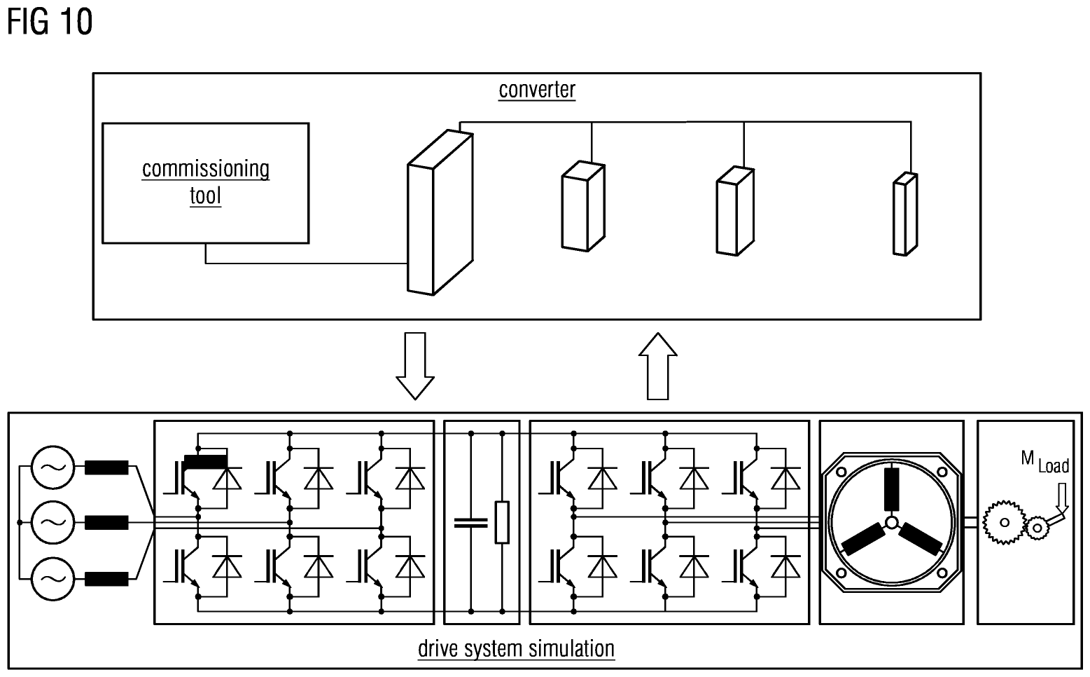

With regard to FIG. 9, training and creation of a first machine learning model and a second machine learning model will be explained. A data set may be divided into sub-sets such as a first training data set, a second training data set, and a test data set. The data set may include raw data corresponding to the actual values of the drive system. This data set is thus divided in three data sub-sets of different or same sizes. All three, sub-sets may be subject to some preprocessing in order to generate features for the respective machine learning model.

In the case of the first sub-set, this first sub-set may be used to train the first machine learning model. The first machine learning model thus servs to identify the adjustment or control action control according to the first procedure. Therein, the first procedure serves for identifying which control parameters of the control loop are to be adjusted in order to optimize the control loop according to an optimization criterium, such as the symmetrical optimum. As a result of this training, a first machine learning model is obtained. This first machine learning model may then be used by itself or in combination with the second procedure as described in the following.

In case of the second sub-set, the second sub-set may be input into the first machine learning model in order obtain training data for the second procedure. The second procedure includes a second machine learning model to be trained. As a result, a second machine learning model trained on the results of the first machine learning model (e.g., and the features input into the first machine learning model) is obtained. Therein, the results (e.g., only the results) of the first machine learning model describing an adjustment of more than one (e.g., of two or more) of the control parameters of the control loop may be used to train the second machine learning model.

In case of the third sub-set, the third sub-set may be used for testing the first machine learning model and/or the second machine learning model obtained by the training as described in the above. The data set may only be divided in one or two sub-sets (e.g., for training the first machine learning model and the second machine learning model).

With regard to FIG. 10, generation of the data set as shown in FIG. 9 will be described in more detail. In case insufficient data about a drive system and its different application is available, to supplement the existing data or otherwise, a drive system simulation may be used to obtain the data required for training and/or testing purposes. A real converter hardware for controlling the simulated drive system may be used. Such setup is generally known by the term Hardware in the Loop (HiL). The converter may include one or more components (e.g., may have a modular architecture). In addition, the converter may include or may be operatively coupled to sensors for acquiring the measured data. However, in the present case, a drive system simulation that provides input or output signals or data that replaces the real-world data or signals may be used. As shown in FIG. 10, a software application or tool may be used to commission and/or optimize the control loop settings of the converter. Software application is operative to perform one or more of the method acts as described in the above. In other words, the software application may be operative to acquire the actual values of the drive system. Further, the software application may include the one or more machine learning models for inferring one or more adjustments of control parameters of the control loop for improving the control accuracy and for outputting the adjustments for adapting the control parameter values. Further, the software application may be operative to set the control loop parameters according to the adjustment(s) determined.

By way of the methods and systems proposed herein, the control quality of the drive system may be analyzed online and during operation. By triggering a speed setpoint jump, the plant operator may receive a recommendation for one or more control actions in order to adjust the control parameters of the drive system. The plant operator may test the control quality of his drive system himself and thus has the assurance that the control parameters are optimally adjusted to the application.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method of optimizing a control loop of a converter, the method comprising:
acquiring actual values of a drive system powered by the converter;
inferring, based on at least one machine learning model and the actual values, one or more adjustments of control parameters of the control loop for improving control accuracy; and
outputting the one or more adjustments for adapting values of the control parameters values.

2. The method of claim 1, wherein the inferring comprises determining one or more control actions for adjusting one or more of the control parameters.

3. The method of claim 1, wherein the inferring comprises determining a control action from a limited number of control actions,
wherein the control action comprises adjusting a coefficient of a proportional part of the control loop, an integral time of an integral part of the control loop, or a combination of both.

4. The method of claim 3, wherein the control action comprises adjusting an adjustment factor of the respective control parameter value.

5. The method of claim 1, wherein the at least one machine learning model is a combination of multiple different machine learning models.

6. The method of claim 3, further comprising:
outputting, by a first machine learning model of the at least one machine learning model, a classification; and
outputting, by a second machine learning model of the at least one machine learning model, an error-sum.

7. The method of claim 6, wherein at first the control action is determined based on the first machine learning model, and when the determined control action is a combination of adjusting two or more control parameters, a specific combination of adjustments is determined based on the second machine learning model.

8. The method of claim 1, further comprising repeating the acquiring, the inferring, and the outputting until a symmetrical optimum or an absolute value optimum is obtained.

9. A converter comprising:
a processor configured to optimize a control loop of the converter, the processor being configured to optimize the control loop of the converter comprising the processor being configured to:
acquire actual values of a drive system powered by the converter;
infer, based on at least one machine learning model and the actual values, one or more adjustments of control parameters of the control loop for improving control accuracy; and
output the one or more adjustments for adapting values of the control parameters.

10. A method of training a machine learning model, the method comprising:
training the machine learning model based on actual values of a drive system, the actual values comprising actual rotation speed, a rotation speed setpoint, an actual torque, a control difference, or any combination thereof.

11. The method of claim 10, further comprising:
deriving one or more features from the actual values for inputting the one or more features into the machine learning model,
wherein the one or more features comprise relative overshooting of the control difference, rising time of the control difference, moment of a maximal overshooting, time until half of the control difference is achieved, total control time for achieving the control difference, or any combination thereof.

12. The method of claim 11, further comprising assigning one or more labels to the derived one or more features,
wherein the one or more labels correspond to one or more control actions for adjusting control loop settings.

13. The method of claim 10, wherein the machine learning model comprises a K-Nearest neighbor model, a support vector machine or a combination thereof.

14. The method of claim 10, wherein the drive system is a virtual drive system.

15. The method of claim 1, wherein the control loop is a control system of the converter.

16. The method of claim 5, wherein the combination of multiple different machine learning models includes one or more K-Nearest-Neighbor models, one or more support vector machines, or a combination of both.

17. The method of claim 16, wherein the first machine learning model is a K-Nearest-Neighbor model, and the second machine learning model is a support vector machine.

18. The method of claim 17, further comprising:
outputting, by the first machine learning model, a classification for each of a plurality of control actions; and
outputting, by the second machine learning model an error-sum for each of the plurality of control actions.
